(19) United States
(12) Patent Application Publication
(10) Pub. No.: US 2019/0356060 A1
(43) Pub. Date: Nov. 21, 2019

(54) METHOD AND APPARATUS FOR AN ORTHOGONAL ANTENNA ARRAY SYSTEM

(71) Applicant: Metawave Corporation, Palo Alto, CA (US)

(72) Inventors: George Daniel, Palo Alto, CA (US); Maha Achour, Palo Alto, CA (US); Yan Wang, Palo Alto, CA (US)

(21) Appl. No.: 16/417,624

(22) Filed: May 20, 2019

Related U.S. Application Data
(60) Provisional application No. 62/673,814, filed on May 18, 2018.

(51) Int. Cl. H01Q 21/24; G01S 7/03; G01S 7/02

(52) U.S. Cl. CPC H01Q 21/245; G01S 7/025; G01S 7/03

(57) ABSTRACT

Examples disclosed herein relate to a radiating structure including a first metamaterial array having a plurality of elements, a second metamaterial array having a plurality of elements, a transceiver coupled to the first and second metamaterial arrays, and an antenna controller configured to adjust the first metamaterial array to scan angles in a first direction and adjust the second metamaterial array to scan angles in a second direction orthogonal to the first direction.

### CROSS-REFERENCE TO RELATED APPLICATIONS

This application claims priority to U.S. Provisional Application No. 62/673,814, filed on May 18, 2018, and incorporated herein by reference in their entirety.

### BACKGROUND

In a wireless transmission system, such as radar or cellular communications, the size of the antenna is determined by the transmission characteristics. With the widespread application of wireless applications, the footprint and other parameters allocated for a given antenna, or radiating structure, are constrained. In addition, the demands on the capabilities of the antenna continue to increase, such as increased bandwidth, finer control, increased range and so forth. In automated applications, such as self-driving vehicles, the radar and other sensors are expected to scan the environment of the vehicle with sufficient speed to enable instructions to the vehicle and response time.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein

FIG. 1 illustrates an antenna system according to various examples;

FIG. 2 illustrates an antenna system having orthogonal transmission and receive arrays in accordance with various examples;

FIG. 3 illustrates a corporate feed for a transmission line array, such as for a radiating structure according to various examples;

FIGS. 4-5 illustrate radiation patterns of the antenna system having orthogonal transmission and receive arrays, according to various examples;

FIG. 6 illustrates a detection pattern of the orthogonal antenna arrays, according to various examples;

FIG. 7 illustrates an antenna feed layer and radiating layer, according to various examples;

FIG. 8 illustrates antenna structures, according to various examples;

FIGS. 9-10 illustrate orthogonal antennas and their active aperture, according to various examples;

FIG. 11 illustrates a method of operation for an antenna system, according to various examples;

FIGS. 12-14 illustrate antenna systems, according to various examples; and

FIG. 15 illustrates transmission schemes, according to various examples.

### DETAILED DESCRIPTION

Methods and apparatuses for an orthogonal antenna array system are disclosed. The orthogonal antenna array system enables steering of beamforms on orthogonal axes, wherein the intersection of the beamform patterns has a directivity referred to herein as an artificial directivity or an effective directivity. In such systems, where a transmission pattern is on a first axis, such as a horizontal or azimuth axis, and a receive pattern is on a second axis orthogonal to the first axis, such as a vertical or elevation axis, the intersection of the patterns provides artificially enhanced directivity where a horizontal beam intersects with a vertical beam. Where the transmit and/or receive antenna represents an array of meta-structure or metamaterial cells that may be arranged into functional subarrays, there are a number of potential intersecting beams as the various beamforms cross. The various examples described herein enable a system to transmit signals along one axis and receive signals along another axis. In the disclosed examples, the geometries of the transmit and receive antennas are orthogonal.

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

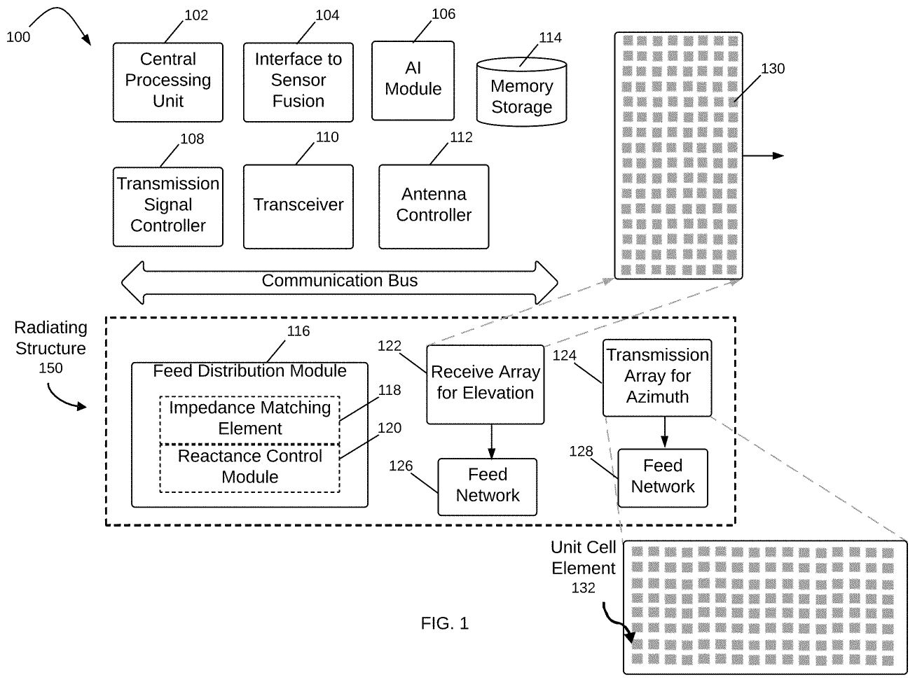

Referring now to FIG. 1, a schematic diagram of an orthogonal antenna system in accordance with various examples is described. FIG. 1 illustrates a system 100 having a radiating array structure 150 coupled to an antenna controller 112, a central processor 102, and a transceiver 110. A transmission signal controller 108 generates a transmission signal, such as a Frequency Modulated Continuous Wave (“FMCW”), which is used for radar sensor applications as the transmitted signal is modulated in frequency, or phase. The FMCW signal enables a radar to measure range to an object by measuring the phase differences in phase or frequency between the transmitted signal and the received signal, or reflected signal. Other modulation types may be incorporated according to the desired information and specifications of a system and application. Within FMCW formats, there are a variety of modulation patterns that may be used within FMCW, including triangular, sawtooth, rectangular and so forth, each having advantages and purposes. For example, sawtooth modulation may be used for large distances to a target; a triangular modulation enables use of the Doppler frequency, and so forth.

The received information is stored in a memory storage unit 114, wherein the information structure may be determined by the type of transmission and modulation pattern. The transmission signal controller 108 may generate a cellular modulated signal, such as an Orthogonal Frequency Division Multiplexing (“OFDM”) signal. In some systems, the signal is provided to the system 100 and the transmission signal controller 108 may act as an interface, translator or modulation controller, or otherwise as required for the signal to propagate through a transmission line system.

In operation, the antenna controller 112 receives information from other modules in system 100 indicating a next radiation beam, wherein a radiation beam may be specified by parameters such as beam width, transmit angle, transmit direction and so forth. The antenna controller 112 determines a voltage matrix to apply to reactance control mechanisms coupled to the radiating structure 150 to achieve a given phase shift or other parameters. In these examples, the radiating array structure 150 is adapted to transmit a directional beam without using digital beam forming methods, but rather through active control of the reactance parameters of the individual elements that make up the arrays.

Transceiver 110 prepares a signal for transmission, such as a signal for a radar device, wherein the signal is defined by modulation and frequency. The signal is received by each element of the radiating structure 150 (e.g., arrays 122-124) and the phase of the radiating arrays 122-124 is adjusted by the antenna controller 112. In some examples, transmission signals are received by a portion, or subarray, of the radiating arrays 122-124. These radiating arrays 122-124 are applicable to many applications, including radar and cellular antennas. The present examples consider application in autonomous vehicles as a sensor to detect objects in the environment of the car. Alternate examples may be applicable in wireless communications, medical equipment, sensing, monitoring, and so forth. Each application type incorporates designs and configurations of the elements, structures and modules described herein to accommodate their needs and goals.

In system 100, a signal is specified by antenna controller 112, which may be in response to Artificial Intelligence (“AI”) module 106 from previous signals, or may be from the interface to sensor fusion 104, or may be based on program information from memory storage 114. There are a variety of considerations to determine the beam formation, wherein this information is provided to antenna controller 112 to configure the various elements of arrays 122-124, which are described herein. The transmission signal controller 108 generates the transmission signal and provides same to feed distribution module 116, which provides the signal to feed networks 126-128 and transmission arrays 122-124. Note that the transmission arrays 122-124 are shown with separate feed networks 126-128, but could in some examples, share the same feed network.

As illustrated, radiating structure 150 includes the arrays 122-124, composed of individual radiating elements discussed herein. The arrays 122-124 may take a variety of forms and are designed to operate in coordination with the feed distribution module 116, wherein individual radiating elements 130-132 correspond to elements within the arrays 122-124. As illustrated, each of the arrays 122-124 is an 8×16 array of unit cell elements 130-132, wherein each of the unit cell elements has a uniform size and shape; however, some examples incorporate different sizes, shapes, configurations and array sizes. When a transmission signal is provided to the radiating structure 150, such as through a coaxial cable or other connector, the signal propagates through the feed distribution module 116 to the feed networks 126-128 and then arrays 122-124 for transmission through the air.

The impedance matching element 118 and the reactance control module 120 may be positioned within the architecture of feed distribution module 116; one or both may be external to the feed distribution module 116 for manufacture or composition as an antenna or radar module. The impedance matching element 118 works in coordination with the reactance control module 120 to provide phase shifting of the radiating signal(s) from arrays 122-124. The present examples are a dramatic contrast to the traditional complex systems incorporating multiple antennas controlled by digital beam forming. Antenna system 100 increases the speed and flexibility of conventional systems, while reducing the footprint and expanding performance.

As illustrated, there are multiple arrays for transmission, where at least one of the arrays is for transmission in the azimuth, or horizontal, direction, transmission array structure for azimuth 124, and the other is for receiving signal over the elevation of the array, receive array 122. The two antennas have orthogonal radiation beams. Note that as illustrated, there are two arrays 122-124. However, radiating structure 150 may incorporate multiple other antenna arrays. In various examples, each antenna array may be for transmission and/or receiving of radiation patterns.

As illustrated in FIG. 1, the antenna system 100 includes modules for control of reactance, phase and signal strength in a transmission line, a power divider circuit, and so forth, along with a control circuit therefor. The control circuit includes a reactance control module (“RCM”) or structure 120, or reactance controller, such as a variable capacitor, to change the reactance of a transmission circuit and thereby control the characteristics of the signal propagating through the transmission line. In some examples, the RCM 120 is a varactor that changes the phase of a signal. In other examples, alternate control mechanisms are used.

For structures incorporating a dielectric substrate to form a transmission path, such as a substrate integrate waveguide (“SIW”), the reactance control structure may be integrated into the transmission line by inserting a microstrip or strip line portion that will support the reactance control modules. Where there is such an interruption in the transmission line, a transition is made to maintain signal flow in the same direction. Similarly, the reactance control structure may require a control signal, such as a DC bias line or other control means, to enable the system to control and adjust the reactance of the transmission line. To isolate the control signal from the transmission signal, examples include a resonant controller that acts to isolate the control signal from the transmission signal. In the case of an antenna transmission structure, the resonant controller isolates the DC control signal from the AC transmission signal.

The present examples are applicable in wireless communication and radar applications, and in particular in meta-structures (“MTS”) capable of manipulating electromagnetic waves using engineered radiating structures. A meta-structure, as generally defined herein, is an engineered, non- or semi-periodic structure that is spatially distributed to meet a specific phase and frequency distribution. In some examples, MTS cells may be metamaterial (“MTM”) cells. Each MTM cell has some unique properties. These properties may include a negative permittivity and permeability resulting in a negative refractive index; these structures are commonly referred to as left-handed materials (“LHM”). The use of LHM enables behavior not achieved in classical structures and materials, including interesting effects that may be observed in the propagation of electromagnetic waves, or transmission signals. Metamaterials can be used for several interesting devices in microwave and terahertz engineering such as antennas, sensors, matching networks, and reflectors, such as in telecommunications, automotive and vehicular, robotic, biomedical, satellite and other applications. For antennas, metamaterials may be built at scales much smaller than the wavelengths of transmission signals radiated by the metamaterial. Metamaterial properties come from the engineered and designed structures rather than from the base material forming the structures. Precise shape, dimensions, geometry, size, orientation, arrangement and so forth result in the smart properties capable of manipulating EM waves by blocking, absorbing, enhancing, or bending waves.

Additionally, the present examples provide methods and apparatuses for generating wireless signals, such as radar signals, having improved directivity and reduced undesired radiation patterns' aspects, such as side lobes. The present examples provide antennas with unprecedented capability of generating Radio Frequency (“RF”) waves for radar systems. These examples provide improved sensor capability and support autonomous driving by providing one of the sensors used for object detection.

The present examples provide smart active antennas with unprecedented capability of manipulating RF waves to scan an entire environment in a fraction of the time of current systems. The present invention provides smart beam steering and beam forming using MTS or MTM radiating structures in a variety of configurations, wherein electrical changes to the antenna are used to achieve phase shifting and adjustment reducing the complexity and processing time and enabling fast scans of up to approximately 360° field of view for long range object detection.

As shown in FIG. 1, a reactance control module 120 is incorporated to adjust the effective reactance of a transmission line and/or a radiating element fed by a transmission line. Such a reactance control module may be a varactor diode having a bias voltage applied by a controller. The varactor diode acts as a variable capacitor when a reverse bias voltage is applied. As used herein, the reverse bias voltage is also referred to herein as reactance control voltage or varactor voltage. The value of the reactance, which in this case is capacitance, is a function of the reverse bias voltage value. By changing the reactance control voltage, the capacitance of the varactor diode is changed over a given range of values. Alternate examples may use alternate methods for changing the reactance, which may be electrically or mechanically controlled. In some examples, a varactor diode may also be placed between conductive areas of a radiating element. With respect to the radiating element, changes in varactor voltage produce changes in the effective capacitance of the radiating element. The change in effective capacitance changes the behavior of the radiating element and in this way the varactor may be considered as a tuning element for the radiating elements in beam formation.

The reactance control module 120 enables control of the reactance of a fixed geometric transmission line. One or more reactance control mechanisms may be placed within a transmission line. Similarly, reactance control mechanisms may be placed within multiple transmission lines to achieve a desired result. The reactance control mechanisms may have individual controls or may have a common control. In some examples, a modification to a first reactance control mechanism is a function of a modification to a second reactance control mechanism.

These examples support autonomous driving with improved sensor performance, all-weather/all-condition detection, advanced decision-making algorithms and interaction with other sensors through sensor fusion. These configurations optimize the use of radar sensors, as radar is not inhibited by weather conditions in many applications, such as for self-driving cars. The ability to capture environmental information early aids control of a vehicle, allowing anticipation of hazards and changing conditions. The sensor performance is also enhanced with these structures, enabling long-range and short-range visibility to the controller. In an automotive application, short-range is considered within 30 meters of a vehicle, such as to detect a person in a cross walk directly in front of the vehicle; and long-range is considered to be 250 meters or more, such as to detect approaching cars on a highway. These examples provide automotive radars capable of reconstructing the world around them and are effectively a radar “digital eye,” having true 3D vision and capable of human-like interpretation of the world.

In some examples, a radar system steers a highly-directive RF beam that can accurately determine the location and speed of road objects. The present examples use radar to provide information for 2D image capability as they measure range and azimuth angle, providing distance to an object and azimuth angle identifying a projected location on a horizontal plane, respectively, without the use of traditional large antenna elements.

The present examples provide methods and apparatuses for radiating structures, such as for radar and cellular antennas, and provide enhanced phase shifting of the transmitted signal to achieve transmission in the autonomous vehicle range, which in the US is approximately 77 GHz and has a 5 GHz range, specifically, 76 GHz to 81 GHz, reduce the computational complexity of the system, and increase the transmission speed. The present examples accomplish these goals by taking advantage of the properties of MTS and MTM structures coupled with novel feed structures. In some examples, these goals are accomplished by taking advantage of the properties of hexagonal structures coupled with novel feed structures. The MTS and MTM antennas may take any of a variety of forms, some of which are described herein for comprehension; however, this is not an exhaustive compilation of the possible embodiments of the present invention.

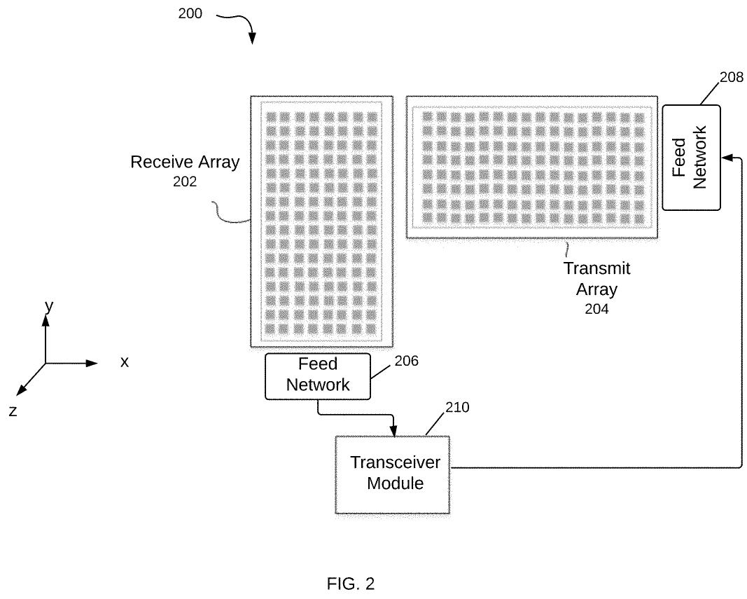

FIG. 2 illustrates a perspective view of one example of a portion of radiating structure 200 including feed network 206 coupled to receive array for elevation 202 and feed network 208 coupled to transmission array for azimuth 204. As illustrated, the array structures 202-204 of this example are each configured as a lattice of unit cells radiating elements. The unit cells are MTS or MTM artificially engineered conductive structures that act to radiate and/or receive the transmission signal. The periodic array structures 202-204 are positioned proximate the feed networks 206-208 respectively, such that the signal fed into the transmission lines of the feed networks 206-208 are received at the lattice structures of arrays 202-204.

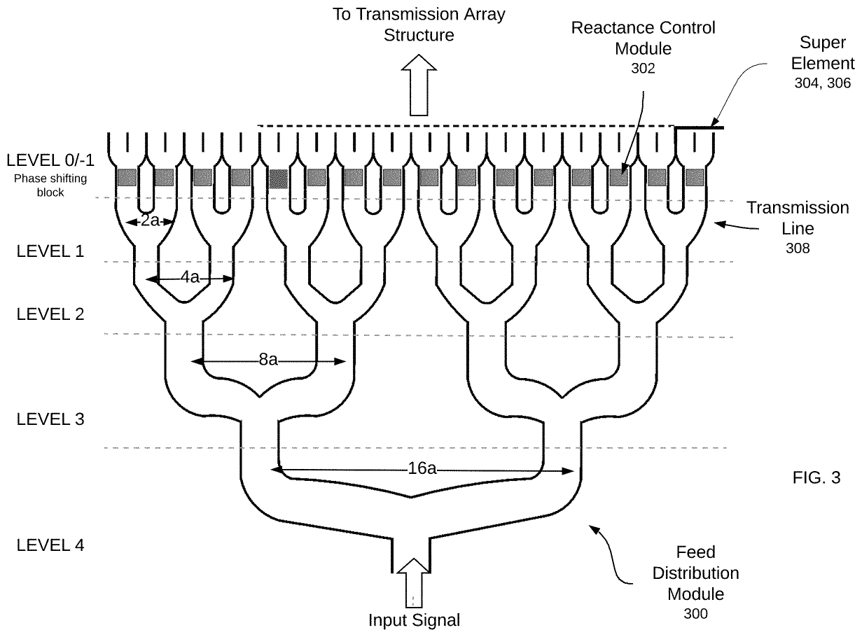

FIG. 3 illustrates a feed distribution module or feed network 116, which may be a power divider circuit. The input signal is fed in through the various paths. This configuration is an example feed network, and is not meant to be limiting to this specific configuration or type of feed network. Each of the division points belongs to a given level of division. The feed distribution module 300 receives an input signal, which propagates to a transmission array structure. On the receive path, signals are received at receive array structure 202 and propagate through the feed network 300. The size of the paths may be configured to achieve a desired transmission and/or radiation result. In the present example, the transmission line 308 of LEVEL 1, includes a reactance control module 302, which changes the reactance of the path (also referred to as a transmission line) resulting in a change to the signal propagating through that path. The reactance control module 302 is incorporated into the path of transmission line 308, but may be coupled to the path in a variety of ways. As illustrated, the other paths of LEVEL 1 have reactance control mechanisms that may be the same as module 302.

The transmission lines are formed in the substrate of the radiating structure 150 of FIG. 1. Transmission line 308 is a part of super element 304 that is split into two transmission lines. The reactance control module 302 is configured on a microstrip within the transmission line structure. Note that the reactance control module 302 may be positioned between transmission lines or may be positioned otherwise within the paths leading to super elements 304, 306.

The present examples provide methods and apparatuses for radiating a signal, such as for radar or wireless communications, using a lattice array of radiating elements and a transmission array and a feed structure. The feed structure distributes the transmission signal throughout the transmission array, wherein the transmission signal propagates along the rows of the transmission array and discontinuities are positioned along each row. The discontinuities are positioned to correspond to radiating elements of the lattice array. The radiating elements are coupled to an antenna controller that applies voltages to the radiating elements to change their electromagnetic characteristics. This change may be an effective change in capacitance that acts to shift the phase of the transmission signal. By phase shifting the signal from individual radiating elements, the system forms a specific beam in a specific direction. A resonant coupler may be used to keep the transmission signal isolated and avoid any performance degradation from any of the processing. In some examples, the radiating elements are MTS or MTM elements. These systems are applicable to radars for autonomous vehicles, drones and communication systems. The radiating elements have a shape that is conducive to dense configurations optimizing the use of space and reducing the size of a conventional antenna.

As illustrated in FIG. 2, the receive array 202 and the transmit array 204 are both coupled to the transceiver 210, and configured such that their radiation beams are orthogonal to each other. One array scans the vertical angles of the field of view, while the other array scans the horizontal angles of the field of view. To scan a direction, the present examples change the reactance of the MTS or MTM unit cells of the array so as to phase shift the output radiation beam. The phase shifting enables the radiating structure 150 to scan in the vertical or elevation with one array while the other array is phase shifted to scan the horizontal or azimuth. The receive array 202 is controlled so that it scans the elevation angle range, and the transmit array 204 is controlled so that it scans the azimuth angle range.

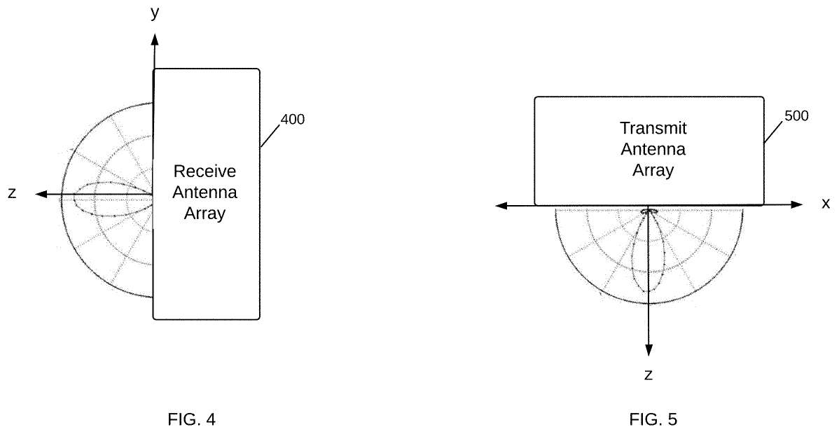

FIG. 4 illustrates the receive antenna array 400 with the radiating beam directed in the z-direction, wherein the reactance of the individual unit cells of the array 400 are adjusted to change the phase of the radiated signal and thereby scan in the y-direction. The radiation beam illustrated identifies a receive area of the array 400, meaning that the array 400 is able to detect objects within that area.

FIG. 5 illustrates the transmit antenna array 500 with radiating beam directed in the z-direction, wherein the reactance of the individual unit cells of the array 500 are adjusted to change the phase of the radiated signal and thereby scan in the y-direction. The radiation beam illustrated identifies a transmit area of the array 500, meaning that the array 500 is used to detect objects within that area.

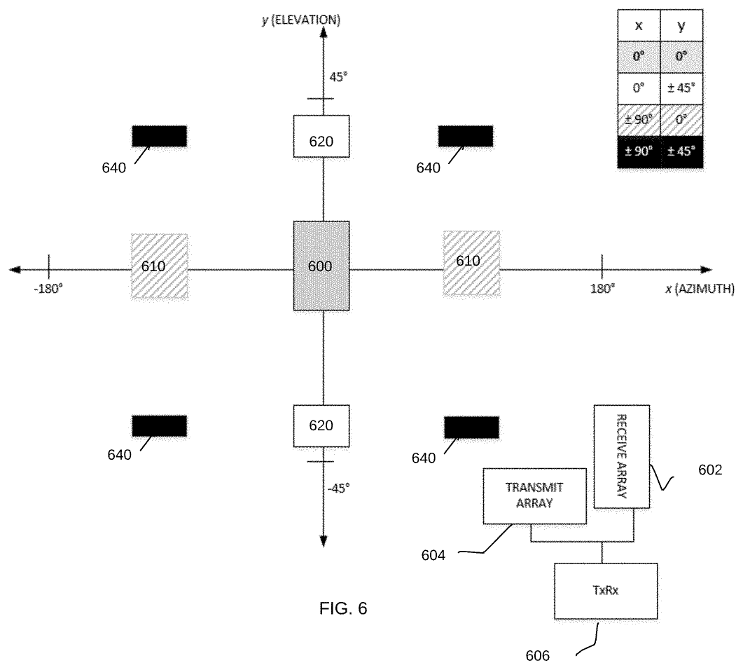

Note that both the arrays 400, 500 are directed into the z-direction, so they have an overlap region as they scan. The cross-over areas are illustrated in FIG. 6 for several angle pairs. For example, when the array 604 is at 0° (boresight) and array 602 is at 0° (boresight), the overlap region is area 600. For array 604 at angle ±90° and array 602 is at 0° the overlap regions are areas 610. When the array 604 is at 0° and the array 602 is at ±45° the overlap regions are areas 620. And when the array 604 is at ±90° and array 602 is at ±45° the overlap regions are areas 640.

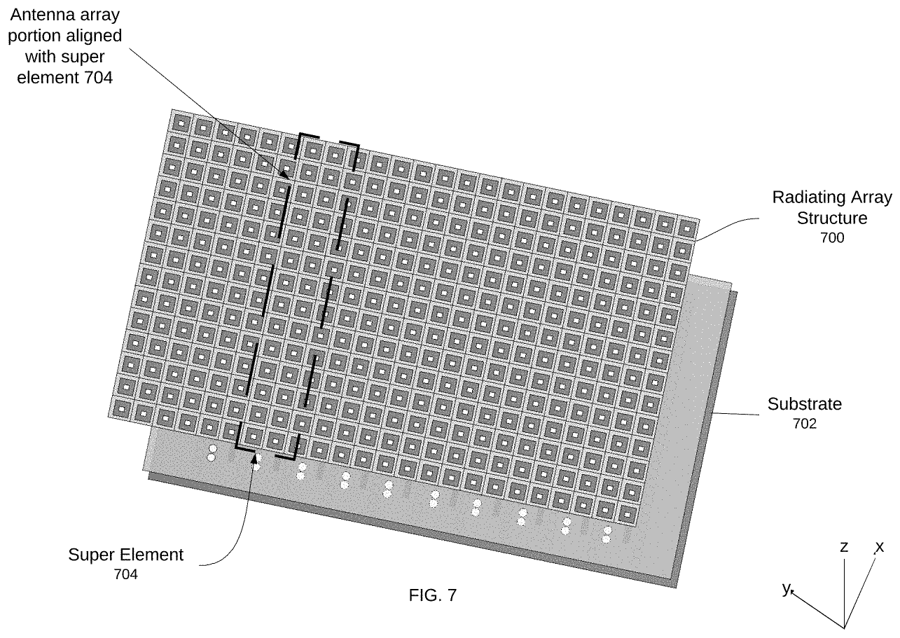

FIG. 7 illustrates a structure incorporating one or multiple antenna arrays. The radiating structure 700 includes a radiating MTM array built on a substrate within which are formed conductive traces separated by gaps. The composite substrate provides transmission paths of the feed to the MTM elements 700 formed thereon. Each MTM element 700 is designed and configured to support the specified radiation patterns. The substrate 702 structure acts as a slotted wave guide to feed the radiating elements. This antenna structure may be referred to as a slotted wave guide antenna (“SWGA”).

The SWGA includes the following structures and components: a full ground plane, a dielectric substrate, a feed network, such as direct feeds to the multi-ports transceiver chipset, an array of antenna or complementary antenna apertures, such as a slot antenna, to couple the electromagnetic field propagating in the Substrate Integrated Waveguide (“SIW”) with MTS or MTM structures located on top of the top of the antenna aperture. The feed network may include passive or active components for matching phase control, amplitude tampering, and other RF enhancement functionalities. The distances between the MTM structures can be much lower than half wavelength of the radiating frequency of the antenna. Active and passive components can be placed on the MTM structures with control signals either routed internally through the SWGA or externally through upper portions of the substrate. MTM structures act as an effective medium presenting their own effective permittivity, which implies a dispersive media that adjusts the phase with radiating frequencies. The difference between the effective permittivity of separate sections of the metamaterial superstrate, realizes a different phase shift for each of the metamaterial cells, resulting in a tilted beam. Alternate examples may reconfigure and/or modify the SWGA structure to improve radiation patterns, bandwidth, side lobe levels, and so forth. The SWGA loads the MTM structures to achieve the desired results.

The composition of an array is illustrated in FIG. 7. The substrate 702 includes multiple layers, and specifically a layer of super elements 704 and a layer of radiating elements 700. Illustrated is the transmit array 124, which is similar in composition to the receive array 122. The feed network provides an input signal to the super elements 704. The substrate 702 has a plurality of super elements 704, wherein each super element includes two transmission lines, each transmission line having a plurality of discontinuities, slots or gaps. The signal propagates through the super elements 704, and is radiated through the slots to the upper layer of radiating elements in radiating structure 700.

The apparatus and structures disclosed herein may be formed as conductive traces on a substrate having a dielectric layer. The feed structure provides the transmission signal energy to each of the array elements by way of multiple parallel transmission paths. While the same signal is provided to each MTM element, the antenna controller controls the phase of each transmission line and/or each MTM element by a variable reactance element. For example, a varactor control may be a capacitance control array, wherein each of a set of varactor diodes is controlled by an individual reverse bias voltage resulting in an effective capacitance change to at least one individual MTM element. The varactor then controls the phase of the transmission of each MTM element, and together the entire MTM antenna array transmits an electromagnetic radiation beam. Control of reverse bias voltages or other controls of the capacitance control element may incorporate a Digital-to-Analog Converter (“DAC”) device. The incorporation of a resonant coupler allows separation of the control or other signals that are used in operation of the apparatus.

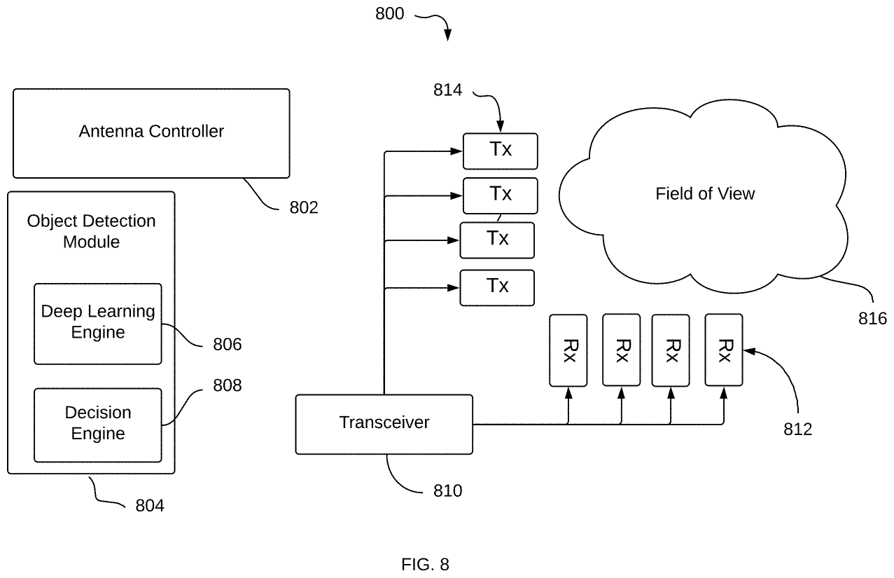

FIG. 8 illustrates an antenna system 800, according to various examples, having a set of transmit antennas 814 and a set of receive antennas 812. In some examples, the sets of antennas may be separate individual antennas. Also in some examples, the sets of antennas are subarrays of one or more metamaterial antenna array(s), where such subarrays may be dynamically controlled. A transceiver 810 is coupled to the sets of antennas 812-814. The antenna system 800 is configured to detect objects, and or communicate, with the field of view 816. The following figures illustrates patterns of various configurations of antenna system 800.

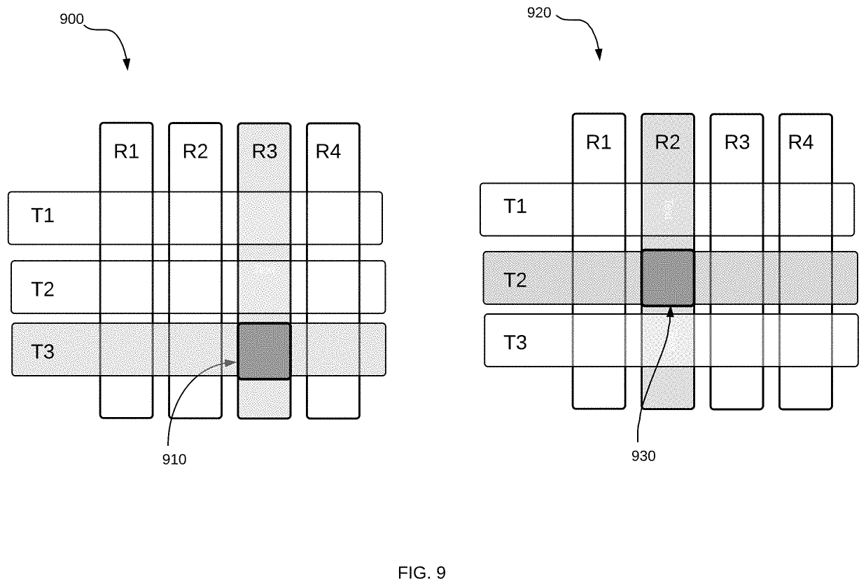

FIG. 9 illustrates the active path or detection areas of various antenna selections. In combination 900, the transmit antenna T3 and receive antenna R3 form active aperture 910. The transmit antennas transmit in a first direction, referred to here as the z-direction, and scan across the horizontal or azimuth in the x-direction. The receive antennas are directed in the z-direction and scan in the vertical or elevation in the y-direction. Each set of antennas, and each individual antenna, has an associated radiation beamform. Where these beamforms will cross or intersect is the active aperture of the antenna system. The active aperture is therefore a combination of the multiple beams, having its own beam width and height. Similarly, in combination 920, the transmit antenna T2 and receive antenna R2 forming active aperture 930.

Note that in FIGS. 8-9, the transmit antennas and receive antennas are orthogonal from each other such that the transmit antennas are at a 0° angle and the receive antennas are at a 90° angle in an x-y plane. This is shown for illustration purposes only. Other configurations are within the scope of the invention, such as, for example, transmit antennas at a 45° degree and receive antennas at an orthogonal 135° angle.

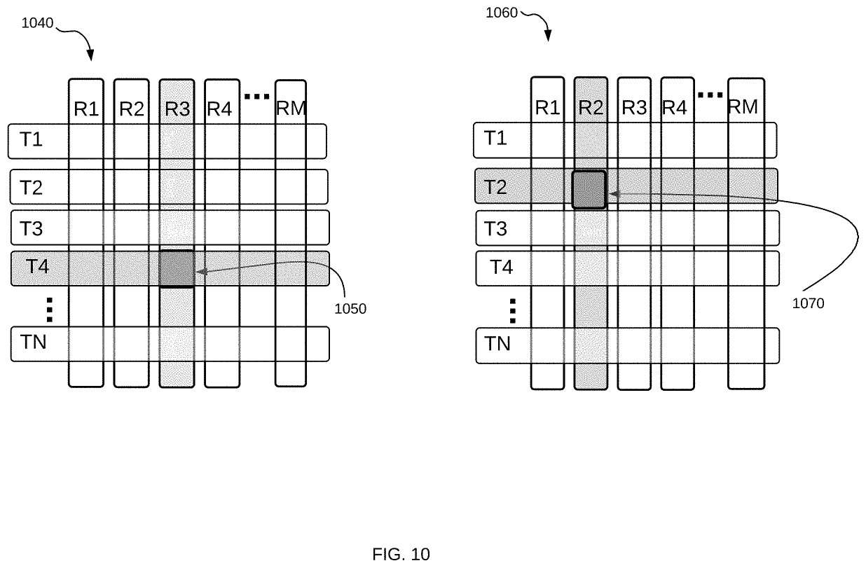

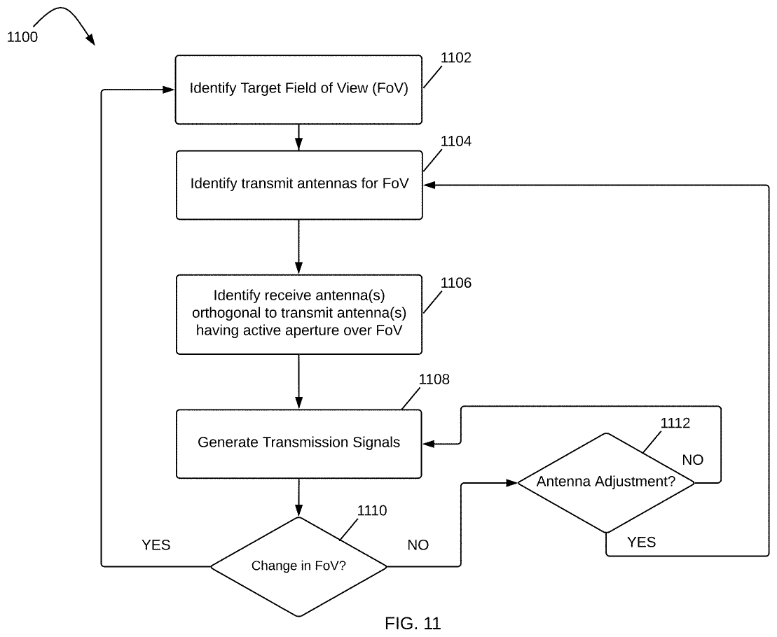

FIG. 10 illustrates configurations 1040, 1060, where there are a number N of transmit and receive antennas. While the illustrated combinations incorporate a common number of transmit and receive antennas, or subarrays, alternate examples may incorporate an unequal number of antennas. The configurations 1040, 1060 of FIG. 10 have resultant active apertures 1050, 1070, respectively. There may be any number of transmit antennas and any number of receive antennas depending on the application and desired field of view.

The system may adjust the active aperture toward a specific field of view or portion of a field of view. The control of the antenna systems may make multiple transmit and/or multiple receive antennas active to achieve a variety of active apertures. As the antenna is made of metamaterial unit cells, the antenna controller is able to quickly and dynamically change its active apertures, such as to follow a user, or respond to a detected object.

FIG. 11 illustrates a method of operating an orthogonal antenna system having an active aperture. The process 1100 begins by identifying the target Field of View (“FoV”), 1102, or communication area. In response, the process identifies a transmit antenna configuration for FoV, 1104, which involves determining how to detect objects within the FoV. The process then identifies a receive antenna configuration which is approximately orthogonal to the transmit antenna configuration, 1106. The combination of the two configurations determines an active aperture for the antenna system, wherein the active aperture is positioned over the FoV. The system generates transmission signals, 1108. If there is a change in the FoV, 1110, the process identifies the new target FoV, 1102. If the antenna configuration needs adjustment, the process returns to identify the transmit antenna configuration, 1104. The process may be implemented for a communications system, wherein the target area is a communication coverage area for user equipment, base stations, fixed wireless components, Internet of Things (IoT) devices, and so forth.

Returning to FIG. 8, in some examples, an object detection module 804 is implemented having a deep learning engine 806 and a decision engine 808. The deep learning engine 806 receives the data from the antenna system 800 and uses artificial intelligence methods, such as a neural network or convolutional neural network, to identify objects and match them to objects on which the engine has trained. This is a quick, reliable form of identification from the radar signals and presents with minimal latency. The decision engine 808 is trained to identify a next configuration of transmit and receive antennas, whereby the decision engine 808 determines a next target FoV and then determines an active aperture that correlates with the FoV. The decision engine 808 then provides guidance or instruction to an antenna controller 802 to implement the control by selecting one or more transmit and one or more receive antennas.

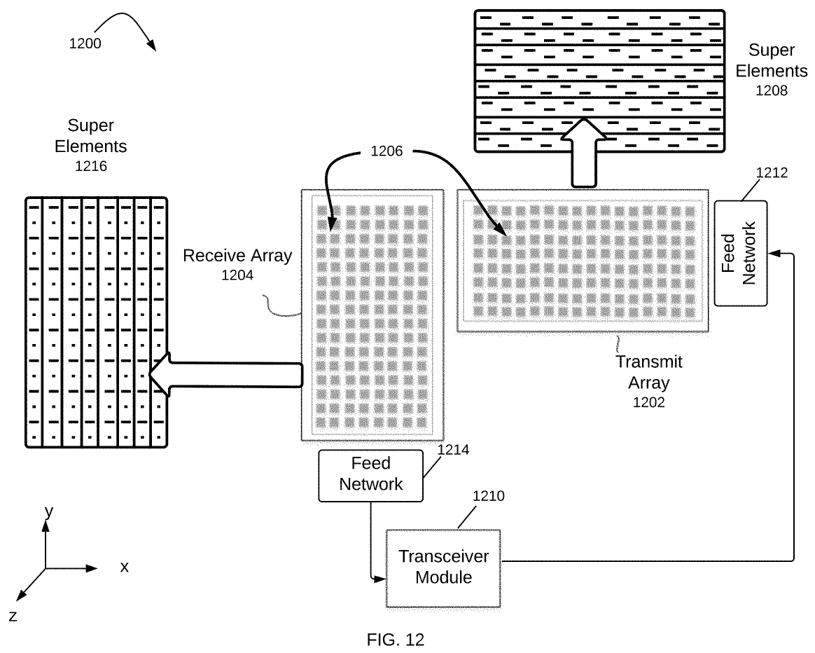

FIG. 12 illustrates a version of antenna system 1200, where the transmit array 1202 includes a set of super elements 1208 arranged as detailed. The super elements 1208 are a set of structures along the length of the transmit array 1202 that underlie the MTM layer of elements and act as a signal feed to the MTM elements 1206. As illustrated, the super elements 1208, 1216 are orthogonal to each other and have scanning beamforms in orthogonal directions. The receive array 1204 includes super elements 1216 that underlie receive array 1204 and act to feed signals to MTM elements 1206. The super elements 1208, 1216 are configured along a length of their corresponding transmit array 1202 and receive array 1204, wherein the slots are configured orthogonally to each other. In this way, the resultant beamforms are orthogonal to each other.

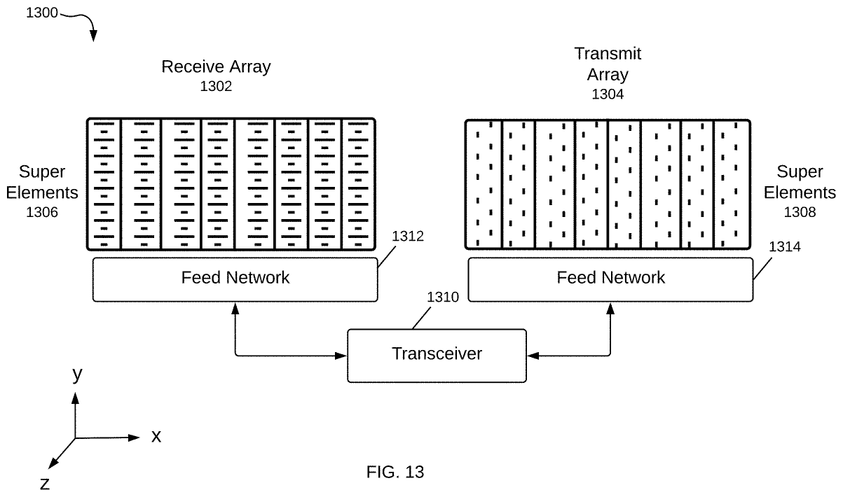

FIG. 13 illustrates a system 1300 having a configuration of receive array 1302 and transmit array 1304 each coupled to a transceiver 1310 through feed networks 1312, 1314, respectively. The receive array 1312 includes multiple super elements 1306; the transmit array 1304 includes multiple super elements 1308. The geometries of the arrays are positioned to achieve orthogonal radiation beam patterns. The transmit array 1304 transmits the signals, while the receive array 1302 receives the reflections of the transmitted signals.

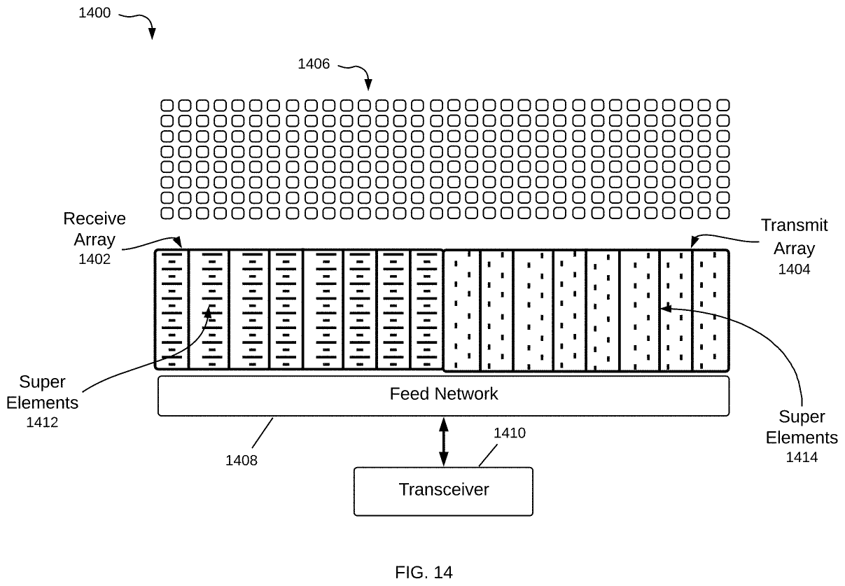

FIG. 14 illustrates a configuration of an example antenna system, wherein antenna system 1400 has a single array 1406 of MTM elements. The MTM elements may be configured into subarrays of elements such that a portion of the elements are aligned with super elements 1412 of receive array 1402, and another subarray are aligned with transmit array 1404 and fed by the super elements 1414. The receive array 1402 and the transmit array 1404 are coupled to feed network 1408 that is coupled to transceiver 1410. In this way, either side may be used for transmit or receive depending on application. The control for the MTM elements of array 1406 is achieved through controls (not shown) and may be integrated into the feed network 1408. The array 1406 may be subdivided into any number of different arrays to transmit and/or receive different signals.

The various examples provided herein are not meant to be limiting. A system may have any number of transmit antennas and/or any number of receive antennas, wherein the number of transmit antennas may be different than the number of receive antennas. The MTM elements may be any of a variety of configurations depending on application, design, cost and other criteria.

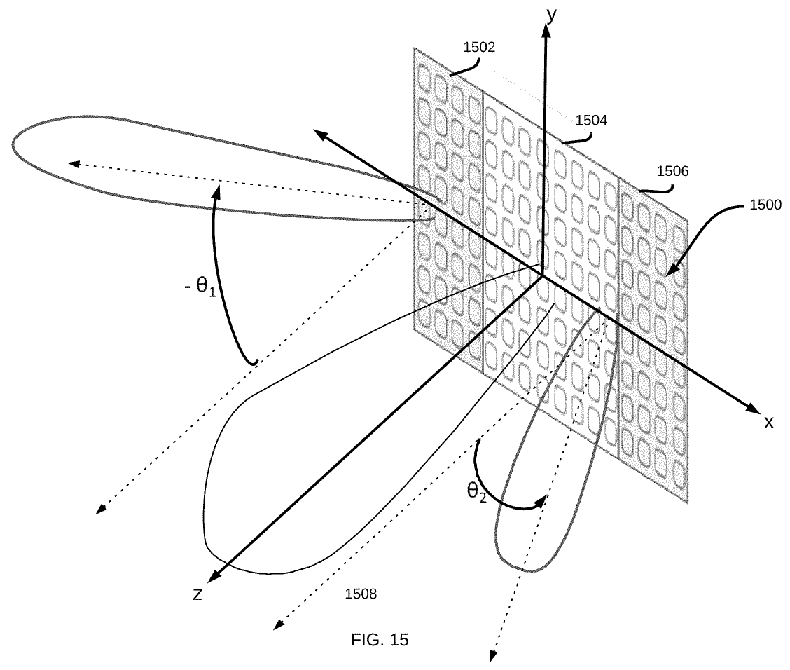

FIG. 15 illustrates various transmission schemes that may be implemented using an antenna according to the present inventions. As illustrated, the MTM antenna array 1500 includes a plurality of individual MTM elements. These are then separated into three subarrays 1502, 1504 and 1506. The generated beamform associated with subarray 1506 is directed in the z-direction and has a center line that is +02 from the boresight direction. The directivity is provided in the horizontal plane (x-z) over which beams scan. It is understood that radiation beamforms are 3-dimensional and also have portions at various elevations as well.

The subarray 1504 has directivity at boresight and therefore forms a 0° angle with boresight. The radiation pattern is illustrated and directed in the z-direction. The subarray 1502 generates a radiation pattern directed in the z-direction and forming an angle −θ₁ from the boresight direction. In this way, a large array of MTM elements may be divided into subarrays, each having associated radiation patterns that are directed and shaped differently. Note, also the subarrays may be a configuration of transmit and receive subarrays and need not all be similarly used.

In these various illustrations, the transmit and receive antenna arrays may be spatially positioned to achieve desired radiation patterns. In some examples, the transmit antennas and receive antennas are portions, or subarrays, of a metamaterial array. The present examples provide antennas and antenna systems using orthogonal antenna arrays to generate artificial directivity that reduces the number and size of antenna elements, reduces the phase shifting mechanisms, reduces or eliminates digital circuitry, and so forth.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A radiating structure, comprising:
a first metamaterial array having a plurality of elements;
a second metamaterial array having a plurality of elements;
a transceiver coupled to the first and second metamaterial arrays; and
an antenna controller configured to adjust the first metamaterial array to scan angles in a first direction and adjust the second metamaterial array to scan angles in a second direction orthogonal to the first direction.

2. The radiating structure of claim 1, further comprising:
a first feed network coupled between the transceiver and the first metamaterial array; and
a second feed network coupled between the transceiver and the second metamaterial array.

3. The radiating structure of claim 1, wherein to adjust the first metamaterial array comprises to adjust a reactance of the first metamaterial array.

4. The radiating structure of claim 4, wherein to adjust the second metamaterial array comprises to adjust a reactance of the second metamaterial array.

5. The radiating structure of claim 4, wherein the antenna controller is configured to adjust the first reactance and the second reactance to achieve scan angles having at least one overlap region.

6. An antenna system to identify an object in a field of view, the antenna system comprising:
a plurality of meta-structure transmit antennas;
a plurality of meta-structure receive antennas orthogonal to the plurality of meta-structure transmit antennas; and
an antenna controller to select one or more meta-structure transmit antennas from the plurality of meta-structure transmit antennas and one or more receive antennas from the plurality of meta-structure receive antennas as instructed by a decision engine in an object detection module.

7. The antenna system of claim 6, further comprising a transceiver coupled to the plurality of meta-structure transmit antennas and the plurality of meta-structure receive antennas.

8. The antenna system of claim 6, wherein the plurality of meta-structure transmit antennas transmit signals in a horizontal direction and the plurality of meta-structure receive antennas transmit signals in a vertical direction.

9. The antenna system of claim 6, wherein each meta-structure transmit antenna has an associated transmit beamform.

10. The antenna system of claim 9, wherein each meta-structure receive antenna has an associated receive beamform.

11. The antenna system of claim 10, wherein the associated transmit beamform for each meta-structure transmit antenna and the associated receive beamform for each meta-structure receive antenna form an active aperture.

12. The antenna system of claim 6, further comprising an array of meta-structure elements configured into a plurality of subarrays.

13. The antenna system of claim 12, wherein a subarray from the array of meta-structure elements is aligned with a set of super elements in a meta-structure transmit antenna and another subarray from the array of meta-structure elements is aligned with a set of super elements in a meta-structure receive antenna.

14. The antenna system of claim 12, wherein the array of meta-structure elements comprises an array of metamaterial cells.

15. A method of operating an orthogonal antenna system having an active aperture, comprising:
identifying a target field of view;
identifying a set of transmit antennas for the target field of view;
identifying a set of receive antennas for the target field of view, the set of receive antennas orthogonal to the set of transmit antennas;
generating a set of transmission signals;
determining if there is a change in the target field of view to identify a new field of view; and
determining a new configuration of transmit and receive antennas based upon a detection of an object in the new field of view.

16. The method of claim 15, wherein the set of transmit antennas comprises a set of meta-structure transmit antennas.

17. The method of claim 15, wherein the set of receive antennas comprises a set of meta-structure receive antennas.

18. The method of claim 15, wherein determining if there is a change in the target field of view comprises detecting an object in the target field of view.

19. The method of claim 15, wherein determining a new configuration of transmit and receive antennas comprises determining a new active aperture.

20. The method of claim 19, wherein the new active aperture is correlated with the new field of view.
